(19) United States
(12) Patent Application Publication
(10) Pub. No.: US 2017/0106740 A1
(43) Pub. Date: Apr. 20, 2017

(54) HEAT EXCHANGER FOR VEHICLE AND HEAT EXCHANGING SYSTEM HAVING THE SAME

(71) Applicant: DENSO International America, Inc., Southfield, MI (US)

(72) Inventors: Nicholas Ingarra, Macomb, MI (US); Jason Spenny, Berkley, MI (US); YuanPei Song, Southfield, MI (US); Sergio Pujols, Canton, MI (US)

(21) Appl. No.: 14/882,891

(22) Filed: Oct. 14, 2015

(51) Int. Cl. B60K 11/08; F01P 11/10; F01P 5/06; B60K 11/04

(52) U.S. Cl. CPC B60K 11/08; B60K 11/04; F01P 11/10; F01P 5/06

(57) ABSTRACT

A heat exchanger includes a core including a plurality of tubes and a plurality of air passages, an air inlet portion in fluid communication with the air passages, and an air outlet portion in fluid communication with the air passages. The tubes and the air passages are alternately arranged to be parallel with each other. The core extends along a core plane defined by the tubes and the air passages. The core is disposed such that the core plane is parallel to a vehicle horizontal plane. Outside air flows through the air passages in a first direction. Thermal medium flows through the tubes in a second direction opposite to the first direction. The air inlet portion is open at a front side of the vehicle or a lateral side of the vehicle. The air outlet portion is open at the front side of the vehicle or the lateral side of the vehicle.

### TECHNICAL FIELD

The present disclosure relates to a heat exchanger for a vehicle and a heat exchanging system having the heat exchanger.

### BACKGROUND

A heat exchanger, such as a radiator, has been used in a vehicle to exchange heat between a thermal medium and outside air to cool, for example, an internal combustion engine. Generally, the heat exchanger is installed inside a space formed in a front side where the internal combustion engine is housed.

A conventional heat exchanger for engine cooling includes a plurality of tubes through which thermal medium flows. Each tube extends in a first direction and the tubes are arranged to be parallel to each other. A plurality of air passages are defined between the tubes, and outside air flows through the air passages in a second direction that is perpendicular to the first direction. In other words, the heat exchanger conventionally has a cross-flow structure where thermal fluid and outside air flow in directions that are perpendicular to each other.

### SUMMARY

This section provides a general summary of the disclosure, and is not a comprehensive disclosure of its full scope or all of its features.

An aspect of the present disclosure provides for a heat exchanger that includes a core including a plurality of tubes and a plurality of air passages, an air inlet portion in fluid communication with the air passages, and an air outlet portion in fluid communication with the air passages. The tubes and the air passages are alternately arranged to be parallel with each other. The core extends along a core plane defined by the tubes and the air passages. The core is disposed such that the core plane is parallel to a vehicle horizontal plane. Outside air flows through the air passages in a first direction. Thermal medium flows through the tubes in a second direction opposite to the first direction. The air inlet portion is open at a front side of the vehicle or a lateral side of the vehicle. The air outlet portion is open at the front side of the vehicle or the lateral side of the vehicle.

According to an aspect of the preset disclosure, outside air flows through the air passages in the first direction and thermal medium flows through the tubes in the second direction. The core may be disposed such that the core plane is parallel to a vehicle horizontal plane. Further, the air inlet portion and the air outlet portion are open at at least one of a front side of the vehicle and a lateral side of the vehicle.

### BRIEF DESCRIPTION OF THE DRAWINGS

The above and other objects, features and advantages of the present invention will become more apparent from the following detailed description made with reference to the accompanying drawings. In the drawings:

FIG. 1 is a side view illustrating a vehicle to which a heat exchanging system according to a first embodiment is applied;

FIG. 2 is a plane view schematically illustrating the heat exchanging system according to the first embodiment;

FIG. 3 is a perspective view schematically illustrating a heat exchanger according to the first embodiment;

FIG. 4 is a front view schematically illustrating a vehicle to which a heat exchanging system according to a second embodiment is applied;

FIG. 5 is a side view of the vehicle according to the second embodiment is applied;

FIG. 6 is a plane view schematically illustrating the heat exchanging system according to the second embodiment;

FIG. 7 is a front view of a vehicle according to a comparative example;

FIG. 8 is a side view of a vehicle to which a heat exchanging system according to a third embodiment is applied; and

FIG. 9 is a plane view schematically illustrating the heat exchanging system according to the third embodiment.

Further areas of applicability will become apparent from the description provided herein. The description and specific examples in this summary are intended for purposes of illustration only and are not intended to limit the scope of the present disclosure.

### DETAILED DESCRIPTION

A plurality of embodiments of the present disclosure will be described hereinafter referring to drawings. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts may be combined. The embodiments may be partially combined even if it is not explicitly described that the embodiments may be combined, provided there is no harm in the combination.

### First Embodiment

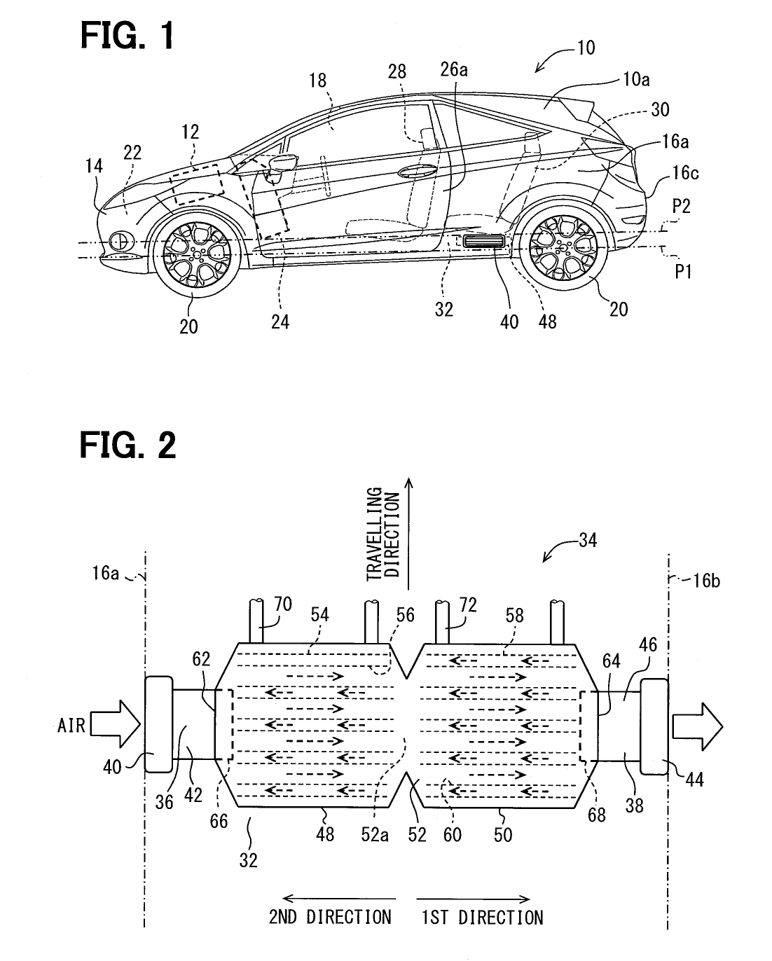

FIG. 1 is a side view illustrating a vehicle 10 to which a heat exchanging system according to the present embodiment is applied. The vehicle 10 is powered by an internal combustion engine (hereinafter “engine”) 12 by combusting fuel such as gasoline. The vehicle 10 includes a main body 10a and a chassis (not shown).

The main body 10a is formed of a front side 14, two lateral sides 16a, 16b and a rear side 16c. The lateral side includes a left side 16a and a right side 16b of the vehicle 10. It should be noted that the left side 16a and the right side 16b are referred when the vehicle 10 is viewed from the rear side 16c to the front side 14. The main body 10a defines a vehicle cabin 18 therein and the chassis supports the main body 10a.

The vehicle 10 further includes two pairs of wheels 20, and each pair of wheels 20 is rotatably connected to the chassis through an axle (not shown).

The engine 12 is housed in a front space (space) 22 formed between the front side 14 of the vehicle 10 and the vehicle cabin 18. An air conditioning unit (air conditioner) 24 for controlling a temperature in the vehicle cabin 18 is housed inside the front space 22 behind the engine 12. The vehicle 10 includes a left door 26a (vehicle door) rotatably connected to the left side 16a and a right door 26b (vehicle door) rotatably connected to the right side 16b. Two front passenger seats 28 and two rear passenger seats 30 are disposed inside the vehicle cabin 18. As show in FIG. 1, an under space (space) 32 is formed below the two rear passenger seats 30.

Here, a vehicle horizontal plane P1 is introduced for subsequent description of the present embodiment. The vehicle horizontal plane P1 is an imaginary plane that is defined by the axle and a traveling direction of the vehicle 10 (refer to FIG. 1). It should be understood that the vehicle horizontal plane P1 may be substantially parallel to the roadway surface of a road on which the vehicle 10 is travelling.

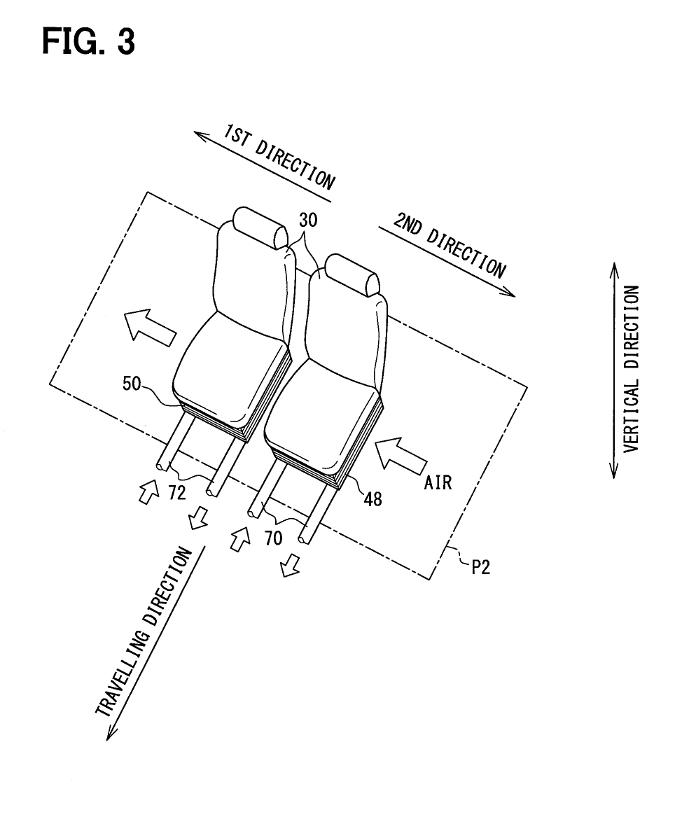

FIG. 2 is a plane view schematically illustrating the heat exchanging system according to the present embodiment. The heat exchanging system may include a heat exchanger 34, a first duct 36, and a second duct 38. Most components of the heat exchanging system are housed inside the under space 32, i.e., the heat exchanging system is positioned below the rear passenger seats 30 (see FIG. 3). In the present embodiment, the first duct 36 serves an intake duct for taking in the outside air and the second duct 38 serves a discharging duct for discharging the outside air.

The first duct 36 may include a first duct opening 40 and a first duct body 42. As shown in FIG. 2, the first duct opening 40 is disposed in one lateral side of the vehicle 10. More specifically, the first duct opening 40 is disposed in the left side 16a of the vehicle 10, whereby the first duct opening 40 is exposed to the outside of the vehicle 10. The first duct opening 40 is open toward the left side of the vehicle 10. The first duct body 42 extends between the first duct opening 40 and the heat exchanger 34 to connect the first duct opening 40 with the heat exchanger 34. That is, the first duct 36 is in fluid communication with the heat exchanger 34.

The second duct 38 may include a second duct opening 44 and a second duct body 46. The second duct opening 44 is disposed in the other lateral side of the vehicle 10. More specifically, the second duct opening 44 is disposed in the right side 16b of the vehicle 10 and is exposed to the outside of the vehicle 10. The second duct opening 44 is open toward the right side of the vehicle 10. The second duct body 46 extends between the heat exchanger 34 and the second duct opening 44 to connect the second duct opening 44 with the heat exchanger 34. That is, the second duct 38 is in fluid communication with the heat exchanger 34. In other words, the second duct 38 is in fluid communication with the first duct 36 through the heat exchanger 34.

The heat exchanger 34 may include a core 48, 50 and a core case 52. The core has a plurality of tubes and a plurality of air passages. In the present embodiment, the core is formed of a first core 48 and a second core 50, and the two cores 48, 50 are covered by the core case 52. More specifically, the core case 52 defines therein a housing space 52a, and the first core 48 and the second core 50 are housed inside the housing space 52a. Hereinafter, the tubes and the air passages for the first core 48 are referred as “first tubes 54” and “first air passages 56”, respectively. Similarly, the tubes and the air passages for the second core 50 are referred as “second tubes 58” and “second air passages 60”, respectively.

An inlet portion 62 is formed at one side of the core case 52 and an outlet portion 64 is formed at the other side of the core case 52 that is opposite to the one side of the core case 52. More specifically, the air inlet portion 62 is located at the left side of the core case 52, and the air outlet portion 64 is located at the right side of the core case 52. The air inlet portion 62 serves an inlet for taking in the outside air to the heat exchanger 34, and the air outlet portion 64 serves an outlet for discharging the outside air from the heat exchanger 34. The air inlet portion 62 is connected to the first duct body 42 to be in fluid communication with the first duct 36. As a result, the air inlet portion 62 is in fluid communication with the first duct opening 40. Accordingly, the air inlet portion 62 is open at the left side 16a of the vehicle 10 through the first duct opening 40, and thus in fluid communication with the outside of the vehicle 10.

As shown in FIG. 2, an intake fan (blower) 66 may be disposed in the core case 52 to blow the outside air into the heat exchanger 34. More specifically, the intake fan 66 is located adjacent to the air inlet portion 62. Further, a discharging fan (blower) 68 may be disposed in the core case 52 to discharge the outside air from the core 48, 50. More specifically, the discharging fan 68 is located adjacent to the air outlet portion 64. By providing the intake fan 66 and the discharging fan 68, the outside air is blown into the heat exchanger 34 from the first duct opening 40 and blown out of the heat exchanger 34 from the second duct opening 44. In other words, a flow of the outside air from the left side 16a to the right side 16b of the vehicle 10 may be generated by the intake fan 66 and the discharging fan 68.

As shown in FIG. 3, the first core 48 is made of a plurality of layers that are stacked with each other along a vertical direction. The vertical direction is substantially perpendicular to the vehicle horizontal plane P1. Each layer includes a plurality of the first air passages 56 and a plurality of the first tubes 54. As shown in FIG. 2, each first tube 54 and each first air passage 56 are alternately arranged to be parallel with each other such that the first core 48 forms a substantially rectangular shape. The first core 48 extends along a core plane P2. The core plane P2 is an imaginary core plane P2 that is defined by the first tubes 54 and the first air passages 56, which are coplanar. In other words, the first core 48 has a quadrangular prism shape extending along the core plane P2. As shown in FIG. 2, the core plane P2 is substantially in parallel to the above-described vehicle horizontal plane P1. In other words, the first core 48 is disposed in the under space 32 such that the core plane P2 is in parallel to the vehicle horizontal plane P1.

Each first air passage 56 is in fluid communication with the air inlet portion 62, and thus the outside air flows into the first air passages 56 through the air inlet portion 62. In the present embodiment, the outside air flows through the first air passages 56 in a first direction (i.e., from the left side 16a to the right side 16b of the vehicle 10 in FIG. 2).

The first tubes 54 are in fluid communication with the air conditioning unit 24 through a first fluid pipe 70. In other words, the first tubes 54 and the first fluid pipe 70 form a portion of a refrigerant circulating circuit of the air conditioning unit 24 where refrigerant, as thermal medium, circulates. Thus, the first core 48 serves as a condenser where the refrigerant flows through the first tubes 54. As shown in FIG. 2, the refrigerant flows through the first tubes 54 along a second direction, which is opposite to the first direction (i.e., from the right side 16b to the left side 16a in FIG. 2). That is, the first core 48 has a counter-flow structure where the refrigerant and the outside air flow in opposite directions. Heat is exchanged between the outside air and the refrigerant while the outside air and the refrigerant are flowing through the first core 48 in the opposite directions.

Most components of the second core 50 are generally the same as those of the first core 48. The second core 50 may be arranged adjacent to the first core 48 in series. More specifically, the first core 48 and the second core 50 are arranged along the first direction in the present embodiment (refer to FIG. 2). The second core 50 is formed of a plurality of layers that are stacked with each other along the vertical direction, and each layer includes a plurality of the second air passages 60 and a plurality of the second tubes 58. The second air passages 60 are in fluid communication with the first air passages 56, i.e., in fluid communication with the air inlet portion 62 through the first air passages 56. Thus, the outside air, which passed through the first air passages 56, flows into each second air passage 60 in the first direction. Furthermore, the second air passages 60 are in fluid communication with the air outlet portion 64, and therefore, the second air passages 60 are in fluid communication with the second duct opening 44 through the second duct body 46.

The second tubes 58 are in fluid communication with an engine cooling system (not shown) through a second fluid pipe 72. In other words, the second tubes 58 and the second fluid pipe 72 form a portion of a coolant circulating circuit where coolant, as thermal medium, circulates for cooling the engine 12. Thus, the second core 50 serves as a radiator where the coolant flows through the second tubes 58. As shown in FIG. 2, the coolant flows through the second tubes 58 along the second direction. Thus, as with the first core 48, the second core 50 has a counter-flow structure where the coolant and the outside air flow in opposite directions. In the second core 50, heat is exchanged between the outside air and the coolant while the outside air and the coolant are flowing through the second core 50 in the opposite directions.

Similar to the first core 48, the second air passages 60 and the second tubes 58 are alternately arranged in parallel with each other to form a substantially rectangular shape. The second core 50 also extends along the core plane P2. In other words, the second core 50 is also disposed inside the under space 32 such that the core plane P2 is substantially in parallel with the vehicle horizontal plane P1.

It should be noted that the temperature of the coolant may be generally higher than that of the refrigerant, in other words, the temperature of the first core 48 may be generally lower than that of the second core 50. Thus, the outside air is heat exchanged with the refrigerant having a relatively low temperature first, and then the outside air is heat exchanged with the coolant having a relatively high temperature.

When is the vehicle 10 is traveling, the outside air flows into the first duct body 42 through the first duct opening 40. The outside air is blown toward the first core 48 by the intake fan 66 and then flows into the first core 48 through the air inlet portion 62. At the first core 48, heat is exchanged between the outside air and the refrigerant, which is cooler than the coolant in the second core 50. Since the outside air and the refrigerant flow in the opposite directions as described above, the heat exchange may be effectively performed.

After passing through the first core 48, the outside air flows into the second core 50 where heat exchange is performed between the outside air and the coolant. Since the outside air and the coolant flow in the opposite directions, as with the first core 48, the heat exchange between the outside air and the coolant may be also effectively performed in the second core 50. In this case, the coolant has a higher temperature than the refrigerant. Therefore, the outside air still has sufficient heat exchanging capacity with respect to the coolant in the second core 50 even after heat was exchanged at the first core 48.

The outside air flows out of the second core 50 by the discharging fan 68 and then flows through the second duct body 46. Eventually, the outside air is discharged from the second duct opening 44 into the outside of the vehicle 10.

As described above, the heat exchanger 34 according to the present embodiment includes the core (i.e., the first core 48 and the second core 50) extending along the core plane P2, and the core 48, 50 is disposed inside the under space 32 such that the core plane P2 is substantially in parallel with the vehicle horizontal plane P1. As a result, the core 48, 50 may have a thinner shape in the vertical direction, compared to a heat exchanger 34 with a cross-flow structure. Thus, the heat exchanger 34 may be disposed in a narrow space such as the under space 32 formed under the rear passenger seats 30, thereby contributing to design flexibility of the vehicle 10. Furthermore, since the counter-flow structure is used in the core 48, 50, the heat exchange performance may be sufficiently improved even with the core 48, 50 having the thinner shape.

### Second Embodiment

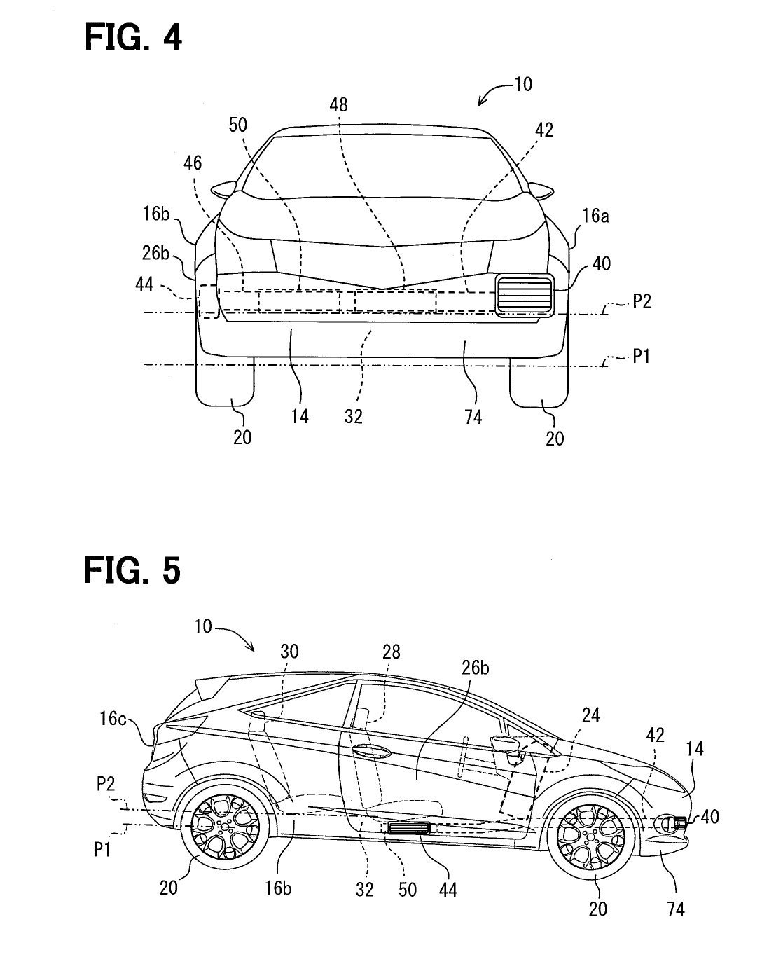

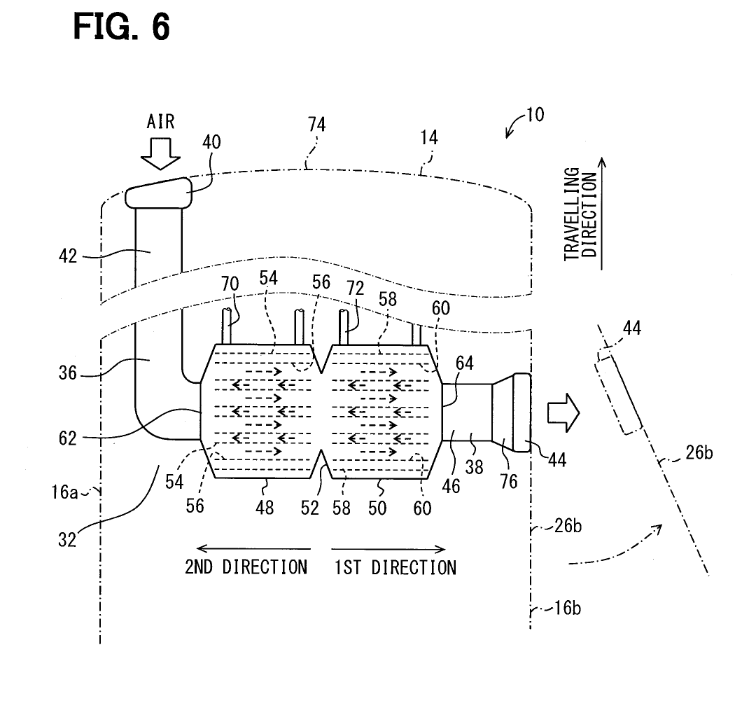

FIG. 4 shows the heat exchanging system according to the second embodiment. In the present embodiment, the first duct opening 40 may be open at the front side 14 of the vehicle 10. More specifically, the first duct opening 40 is disposed in a bumper 74, which forms a portion of the front side 14 of the vehicle 10, to be located on the left side of the bumper 74. The first duct opening 40 is open along the traveling direction of the vehicle 10. The second duct opening 44 in the present embodiment may be disposed in the right side 16b of the vehicle 10. More specifically, the second duct opening 44 is disposed in the right door 26b to be open toward the right side 16b of the vehicle 10, as shown in FIG. 5. As shown in FIG. 6, the second duct opening 44 is integrally formed in the right door 26b, so as to move together with the right door 26b when the right door 26b is opened.

As shown in FIG. 5, the heat exchanger 34 according to the present embodiment may be disposed inside an under space 32 that is defined below the two front passenger seats 28. As with the first embodiment, the first core 48 and the second core 50 are arranged along the first direction in this order, and the outside air flows through the first and second cores 48, 50 in the first direction (refer to FIG. 6). On the other hand, the refrigerant flows through the first core 48 along the second direction and the coolant flows through the second core 50 along the second direction. That is, the counter-flow structure is also used in both the first core 48 and the second core 50 in the second embodiment.

The first duct body 42 may linearly extend between the first duct opening 40 and the air inlet portion 62 along the vehicle horizontal plane P1. Specifically, the first duct body 42 linearly extends along the traveling direction of the vehicle 10. Hence, the air inlet portion 62 is open at the front side 14 (more specifically, the bumper 74) of the vehicle 10 through the first duct body 42 and the first duct opening 40. The second duct body 46 may linearly extend between the second duct opening 44 and the air outlet portion 64 along the vehicle horizontal plane P1. Specifically, the second duct body 46 linearly extends along the first direction (or the second direction). Therefore, the first duct body 42 and the second duct body 46 extend in different directions, i.e., are angled with each other along the vehicle horizontal plane P1.

The air outlet portion 64 according to the present embodiment is open at the right side 16b (more specifically, the right door 26b) of the vehicle 10 through the second duct body 46 and the second duct opening 44. The second duct body 46 is connected to the second duct opening 44 through a connector 76. When the right door 26b is open, the second duct opening 44 is away from the connector 76 (i.e., the second duct body 46), as indicated by the dotted lines in FIG. 6. At this time, the second duct opening 44 is not in fluid communication with the second duct body 46. On the other hand, when the right door 26b is closed, the second duct opening 44 is connected to the connector 76 (i.e., the second duct body 46), as indicated by the solid lines in FIG. 6. At this time, the second duct opening 44 is in fluid communication with the second duct body 46. It should be noted that the intake fan 66 and the discharging fan 68 described in the first embodiment may be eliminated in the second embodiment.

When the vehicle 10 is traveling, the outside air flows into the heat exchanging system through the first duct opening 40. Since the first duct 36 is open at the front side 14 of the vehicle 10 (i.e., the bumper 74), the outside air may be effectively taken in through the first duct opening 40 even without the intake fan 66 or the discharging fan 68 described in the first embodiment. The outside air flows through the core 48, 50 in the first direction while heat is being exchanged between the refrigerant and the outside air at the first core 48 and between the coolant and the outside air at the second core 50. The outside air flows out of the core through the air outlet portion 64 and then is discharged from the second duct opening 44 toward the outside of the vehicle 10.

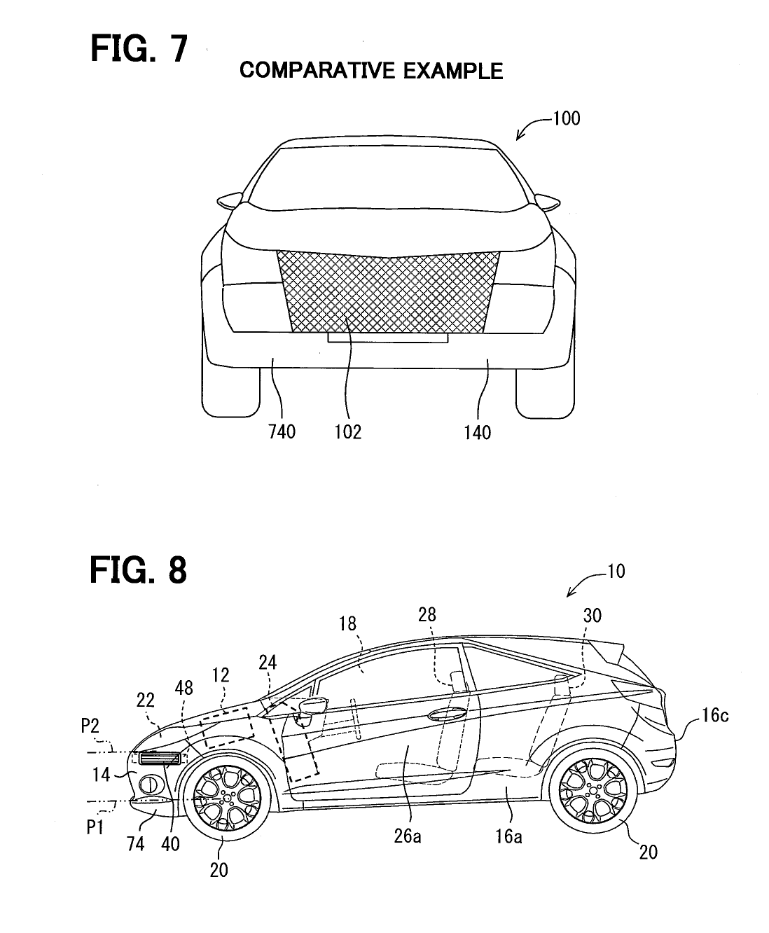

FIG. 7 shows a vehicle 100, as a comparative example, viewed from the front side 140 of the vehicle 100. The vehicle 100 according to the comparative example includes a bumper 740 formed with a front grill 102 at the center of the bumper 740. A heat exchanger (not shown) of the comparative example is disposed behind the front grill 102, and the front grill 102 serves as an intake opening through which outside air is supplied to the heat exchanger 34. On the other hand, the first duct opening 40 according to the present embodiment is disposed at the left side 16a of the bumper 74 as describe above. In other words, a center opening such as the front grill 102 of the comparative example may be eliminated in the present embodiment, whereby design flexibility for the vehicle 10 may be improved.

Furthermore, the core 48, 50 has the counter-flow structure and thus has a thinner shape compared to a core having the cross-flow structure. Hence, similar to the first embodiment, the core 48, 50 may be disposed inside a narrow space such as the under space 32 below the front passenger seats 28, which may provide further design flexibility for the vehicle 10.

### Third Embodiment

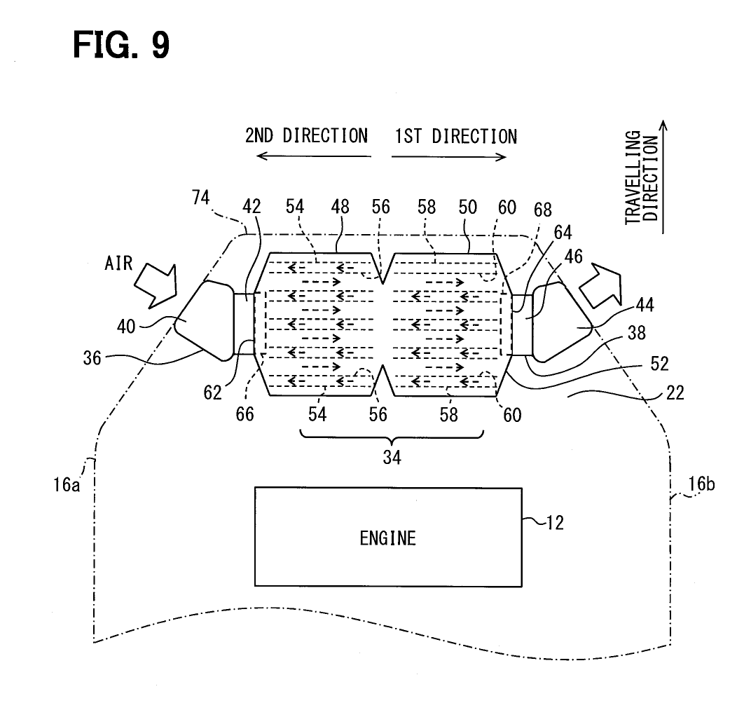

FIGS. 8 and 9 show a heat exchanging system according to the third embodiment. In the present embodiment, the first duct opening 40 and the second opening are disposed in the front side 14 of the vehicle 10, and more specifically, in the bumper 74. As shown in FIG. 9, the first duct opening 40 may be at the left side 16a of the vehicle 10 in the bumper 74 and the second duct opening 44 may be at the right side 16b of the vehicle 10 in the bumper 74. More specifically, the first duct opening 40 is open substantially toward the left side 16a of the vehicle 10 and the second duct opening 44 is open substantially toward the right side 16b of the vehicle 10. As with the second embodiment, the bumper 74 does not have a center opening such as the grill 102 illustrated in FIG. 7.

In the present embodiment, the heat exchanger 34 is disposed in the front space 22 where the engine 12 is housed. The heat exchanger 34 is located between the air conditioning unit 24 and the front side 14 of the vehicle 10, and more specifically, between the engine 12 and the front side 14 of the vehicle 10. As shown in FIG. 9, the first core 48 and the second core 50 are arranged along the first direction in this order. The air inlet portion 62 is open at the left side 16a of the core case 52, and the air outlet portion 64 is open at the right side 16b of the core case 52. The first duct body 42 substantially linearly extends between the first duct opening 40 and the air inlet portion 62, and the second duct body 46 substantially linearly extends between the air outlet portion 64 and the second duct opening 44. Furthermore, the heat exchanger 34 may include the intake fan 66 and the discharging fan 68 to blow the outside air into the core (i.e., the first core 48) and discharge the outside air from the core (i.e., the second core 50).

When the vehicle 10 is traveling, the outside air is taken in through the first duct opening 40 by the intake fan 66. The outside air flows through the first duct body 42, the first core 48, the second core 50 and the second duct body 46 along the first direction, whereas the thermal mediums (i.e., the refrigerant and the coolant) flows through the core 48, 50 along the second direction. That is, the core 48, 50 in the present embodiment also has the counter-flow structure, which allows the core 48, 50 to have a thinner shape in the vertical direction with sufficient heat exchanging performance. Thereafter, the outside air flows out of the heat exchanging system through the second duct opening 44.

As with the above-described embodiments, the core 48, 50 has the thinner shape, which may allow the heat exchanger 34 to be disposed in a small space such as the front space 22. Especially, because the core 48, 50 is smaller in the vertical direction than a core having a cross-flow structure, the core 48, 50 may be disposed at a front position in the front space 22 as shown in FIG. 8. Thus, a relatively large space between the heat exchanger 34 and the engine 12 may be formed in the front space 22, which may provide improved design flexibility of the vehicle 10.

### Other Embodiments

In the above-described embodiments, the core 48, 50 is disposed in the under space 32 below the front/rear passenger seats 28, 30 or the front space 22 housing the engine 12. However, the core 48, 50 may be disposed in another space. Since the core 48, 50 has a thinner shape in the vertical direction, the core 48, 50 may be disposed in any narrow space that is restricted in the vertical direction. In the above-described embodiments, the core 48, 50 is disposed such that the core plane P2 is in parallel with the vehicle horizontal plane P1. However, the core 48, 50 may be disposed such that the core plane P2 is slightly angled relative to the vehicle horizontal plane P1 within manufacturing tolerances or installation errors.

In the above-described embodiments, the core 48, 50 includes the first core 48 and the second core 50. However, the core may be formed of a single core, or three or more cores. Further, in the above-described embodiments, the first core 48 serves as a condenser for the air conditioning unit 24. However, the first core 48 may serve as a cooler for cooling equipment, such as an inverter or a battery for a hybrid or electric vehicle 10. Moreover, the first core 48 may serve as a supercharger intercooler for cooling a supercharger. In the above-described embodiments, the second core 50 serves as a radiator for cooling the engine 12. Alternatively, the second core 50 may serve a cooler for cooling a transmission oil.

In the above-described embodiments, the second duct opening 44 is disposed in the front side 14 or the lateral side of the vehicle 10, but the second duct opening 44 may be disposed in a rear side 16c of the vehicle 10. In the second embodiment, the first duct opening 40 is disposed in the bumper 74 at the left side 16a thereof and the second duct opening 44 is disposed in the right side 16b of the vehicle 10. Alternatively, the first duct opening 40 may be disposed in the bumper 74 at the right side thereof and the second duct opening 44 may be disposed in the left side 16a of the vehicle 10. Furthermore, the first duct opening 40 may be disposed in one of the left and right door 26a, 26b and the second duct opening 44 may be disposed in the other of the left and right door 26a, 26b.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed. As used herein, the term “and/or” includes any and all combinations of one or more of the associated listed items.

What is claimed is:

1. A heat exchanger for a vehicle, the heat exchanger comprising:
a core including a plurality of tubes and a plurality of air passages;
an air inlet portion in fluid communication with the plurality of air passages; and
an air outlet portion in fluid communication with the plurality of air passages, wherein
each of the plurality of tubes and each of the plurality of air passages are alternately arranged to be parallel with each other,
the core extends along a core plane defined by the plurality of tubes and the plurality of air passages,
the core is disposed such that the core plane is parallel to a vehicle horizontal plane,
the plurality of air passages receive outside air from the air inlet portion, the outside air flowing through the plurality of air passages in a first direction, and flowing out of the plurality of air passages through the air outlet portion,
thermal medium flows through the plurality of tubes in a second direction opposite to the first direction,
the air inlet portion is open at a front side of the vehicle or a lateral side of the vehicle, and
the air outlet portion is open at the front side of the vehicle or the lateral side of the vehicle.

2. The heat exchanger according to claim 1, wherein
the core is disposed in a space formed under a vehicle seat.

3. The heat exchanger according to claim 1, wherein
the core is disposed in a space formed in front of an air conditioner for the vehicle.

4. The heat exchanger according to claim 1, wherein
the outside air is blown into the air inlet portion toward the air outlet portion by a blower.

5. A heat exchanging system for a vehicle, the heat exchanging system comprising:
a core including a plurality of tubes and a plurality of air passages;
an air inlet portion in fluid communication with the plurality of air passages;
an air outlet portion in fluid communication with the plurality of air passages;
a first duct in fluid communication with the air inlet portion; and
a second duct in fluid communication with the air outlet portion, wherein
each of the plurality of tubes and each of the plurality of air passages are alternately arranged to be parallel with each other,
the core extends along a core plane defined by the plurality of tubes and the plurality of air passages,
the core is disposed such that the core plane is parallel to a vehicle horizontal plane,
the plurality of air passages receive outside air from the air inlet portion, the outside air flowing through the plurality of air passages in a first direction and flowing out of the plurality of air passages through the air outlet portion,
thermal medium flows through the plurality of tubes in a second direction opposite to the first direction,
the air inlet portion is open at a front side of the vehicle or a lateral side of the vehicle through the first duct, and
the air outlet portion is open at the front side of the vehicle or the lateral side of the vehicle through the second duct.

6. The heat exchanging system according to claim 5, wherein
the core is disposed in a space formed under a vehicle seat.

7. The heat exchanging system according to claim 5, wherein
the core is disposed in a space formed in front of an air conditioner for the vehicle.

8. The heat exchanging system according to claim 5, wherein
the first duct includes a first duct opening and a first duct body,
the second duct includes a second duct opening and a second duct body,
the first duct opening is disposed in the front side of the vehicle or the lateral side of the vehicle,
the first duct body is configured to connect the first duct opening with the air inlet portion,
the second duct opening is disposed at the front side of the vehicle or the lateral side of the vehicle,
the second duct body is configured to connect the second duct opening with the air outlet portion, and
the first duct body and the second duct body extend in parallel with the vehicle horizontal plane.

9. The heat exchanging system according to claim 8, wherein
the first duct opening is disposed in the front side of the vehicle,
the second duct opening is disposed in the lateral side of the vehicle, and
the first duct body and the second duct body extend in different directions.

10. The heat exchanging system according to claim 8, wherein
the lateral side of the vehicle includes a left side and a right side that is opposite to the left side,
the first duct opening is disposed in one of the left side and the right side,
the second duct opening is disposed in the other of the left side and the right side, and
the first duct body and the second duct body extend in parallel with each other.

11. The heat exchanging system according to claim 8, wherein
the first duct opening is disposed in a vehicle door that is rotatably connected to the lateral side of the vehicle,
the first duct opening is in fluid communication with the air inlet portion through the first duct body when the vehicle door is closed, and
the first duct opening is not in fluid communication with the air inlet portion through the first duct body when the vehicle door is open.

12. The heat exchanging system according to claim 8, wherein
the second duct opening is disposed in a vehicle door that is rotatably connected to the lateral side of the vehicle,
the second duct opening is in fluid communication with the air outlet portion through the second duct body when the vehicle door is closed, and
the second duct opening is not in fluid communication with the air outlet portion through the second duct body when the vehicle door is open.
